(19) United States
(12) Patent Application Publication
(10) Pub. No.: US 2006/0121810 A1
(43) Pub. Date: Jun. 8, 2006

(54) Nonwoven mats

(75) Inventor: Klein A. Rodrigues, Signal Mountain, TN (US)

Correspondence Address: NATIONAL STARCH AND CHEMICAL COMPANY, P.O. BOX 6500, BRIDGEWATER, NJ, 08807-3300, US

(73) Assignee: NATIONAL STARCH AND CHEMICAL INVESTMENT HOLDING CO RPORATION, New Castle, DE (US)

(21) Appl. No.: 11/276,091

(22) Filed: Feb. 14, 2006

Related U.S. Application Data
(62) Division of application No. 10/606,421, filed on Jun. 26, 2003, now abandoned.
Application No. 10/606,421 is a continuation-in-part of application No. 10/283,406, filed on Oct. 29, 2002.

(51) Int. Cl. B32B 27/02; C08F 20/00; D04H 1/00; B32B 5/02

(52) U.S. Cl. 442/327; 442/152; 442/164; 442/165; 442/169; 442/172; 442/178; 525/444

(57) ABSTRACT

Formaldehyde-free nonwoven mat formed from fibrous substances and a binder composition containing a copolymer having an acid and a hydroxyl, amide or amine functionality. The invention also relates to the use of polyamines as crosslinkers for a polymer binder. The binder composition is especially useful for binding mineral fiber, and particularly as a fiberglass binder. The binder composition provides a strong yet flexible bond that allows compressed fiberglass mats to easily expand once the compression is released.

### CROSS REFERENCE TO RELATED APPLICATIONS

This application is a divisional application of U.S. Ser. No. 10/606,421, filed 26 Jun. 2003, which is a continuation-in-part of U.S. Ser. No. 10/283,406 filed 29 Oct. 2002.

### BACKGROUND OF THE INVENTION

1. Technical Field

The invention relates to a nonwoven mat formed from fibrous substances and a binder composition containing a copolymer having an acid and a hydroxyl, amide or amine functionality. The invention also relates to the use of polyamines as crosslinkers for a polymer binder. The binder composition is especially useful for binding mineral fiber, and particularly as a fiberglass binder. The binder composition provides a strong yet flexible bond that allows a compressed fiberglass mat to easily expand once the compression is released.

2. Background Information

Fiberglass insulation products generally consist of glass fibers bonded together by a polymeric binder. An aqueous polymer binder is sprayed onto matted glass fibers soon after they have been formed, and while they are still hot. The polymer binder tends to accumulate at the junctions where fibers cross each other, holding the fibers together at these points. The heat from the fibers causes most of the water in the binder to vaporize. An important property of the fiberglass binder is that it must be flexible—allowing the fiberglass product to be compressed for packaging and shipping, but recover to its full vertical dimension when installed.

Phenol-formaldehyde binders have been the primary binders in the manufacture of fiberglass insulation. These binders are low-cost and easy to apply and readily cured. They provide a strong bond, yet elasticity and good thickness recovery to obtain the full insulating value. One drawback to phenol-formaldehyde binders is that they release significant levels of formaldehyde into the environment during manufacture. The cured resin can also release formaldehyde in use, especially when exposed to acidic conditions. Exposure to formaldehyde produces adverse health effects in animals and humans. Recent developments have lead to reduced emissions of formaldehyde, as in U.S. Pat. No. 5,670,585, or as in a mixture of phenol formaldehyde binders with carboxylic acid polymer binders, as in U.S. Pat. No. 6,194,512; however formaldehyde emissions remain a concern.

Alternative chemistries have been developed to provide formaldehyde-free binder systems. These systems involve three parts: 1) a polymer (e.g., a polycarboxyl, polyacid, polyacrylic, or anhydride); 2) a cross-linker that is an active hydrogen compound (e.g., trihydric alcohol (see, e.g., U.S. Pat. Nos. 5,763,524 and 5,318,990), triethanolamine (see, e.g., U.S. Pat. No. 6,331,350 and European Patent Application No. 0990728), β-hydroxy alkyl amides (see, e.g., U.S. Pat. No. 5,340,868); or hydroxy alkyl urea (see, e.g., U.S. Pat. Nos. 5,840,822 and 6,140,388) and 3) a catalyst or accelerator such as a phosphorous containing compound or a fluoroborate compound (see, e.g., U.S. Pat. No. 5,977,232).

These alternative binder compositions work well; however, there is a need for alternative fiberglass binder systems that provide the performance advantages of phenol-formaldehyde resins in a formaldehyde-free system.

Surprisingly, it has been found that a polymeric binder having both acid and hydroxyl, amide, or amine groups produces a strong, yet flexible and clear fiberglass insulation binder system. The presence of both the acid and active hydrogen functionalities within the same copolymer eliminates the need for an extra component, and also places the functional groups in close proximity for efficient crosslinking. It has also been found that a polyamine can be used as the crosslinker for polymer binders.

### SUMMARY OF THE INVENTION

The present invention is directed to a nonwoven binder composition, having an aqueous solution comprising a copolymer binder having both acid functionality and hydroxyl, amide, or amine functionality.

The present invention is also directed to a nonwoven binder composition having a polyamine as a crosslinking agent.

The invention is also directed to a bonded fiberglass mat having directly deposited thereon a copolymer binder having an acid and a hydroxyl, amide, or amine functionality.

### DETAILED DESCRIPTION OF THE INVENTION

The present invention relates to a non-woven binder composition containing a copolymer binder synthesized from at least one acid-functional monomer, and having at least one hydroxyl, amide, or amine functional monomer. It also relates to a polyamine crosslinking agent for any polymer binder.

The copolymer binder is synthesized from one or more acid monomers. The acid monomer may be a carboxylic acid monomer, a sulfonic acid monomer, a phosphonic acid monomer, or a mixture thereof. The acid monomer makes up from 1 to 99 mole percent, preferably from 50 to 95 mole percent, and most preferably from 60 to 90 mole percent of the polymer. In one preferred embodiment, the acid monomer is one or more carboxylic acid monomers. The carboxylic acid monomer includes anhydrides that will form carboxyl groups in situ. Examples of carboxylic acid monomers useful in forming the copolymer of the invention include, but are not limited to acrylic acid, methacrylic acid, crotonic acid, isocrotonic acid, fumaric acid, maleic acid, cinnanic acid, 2-methylmaleic acid, itaconic acid, 2-methylitaconic acid, sorbic acid, α-β-methylene glutaric acid, maleic anhydride, itaconic anhydride, acrylic anhydride, methacrylic anhydride. Preferred monomers are maleic acid, acrylic acid and methacrylic acid. The carboxyl groups could also be formed in situ, such as in the case of isopropyl esters of acrylates and methacrylates that will form acids by hydrolysis of the esters when the isopropyl group leaves.

Examples of phosphonic acid monomers useful in forming the copolymer include, but are not limited to vinyl phosphonic acid.

Examples of sulfonic acid monomers useful in forming the copolymer include, but are not limited to styrene sulfonic acid, 2-acrylamido-2-methylpropane sulfonic acid, vinyl sulfonic acid, methallyl sulfonic acid, sulfonated styrene, and allyloxybenzene sulfonic acid.

The copolymer binder is also synthesized from one or more hydroxyl, amide, or amine containing monomers. The hydroxyl, amide, or amine monomer makes up from 1 to 75 mole percent, and preferably 10 to 20 mole percent of the copolymer. Examples of hydroxyl monomers useful in forming the copolymer of the invention include, but are not limited to hydroxypropyl (meth)acrylate, hydroxyethyl (meth)acrylate, hydroxybutyl (meth)acrylate and methacrylate esters of poly(ethylene/propylene/butylene) glycol. In addition, one could use the acrylamide or methacrylamide version of these monomers. Monomers like vinyl acetate that can be hydrolyzed to vinyl alcohol after polymerization may be used. Preferred monomers are hydroxypropyl acrylate and methacrylate. Examples of amine-functional monomers useful in the present invention include, N,N-dialkyl aminoalkyl (meth)acrylate, N,N-dialkyl aminoalkyl (meth)acrylamide, preferably dimethyl aminopropyl methacrylate, dimethyl aminoethyl methacrylate, tert-butyl aminoethyl methacrylate and dimethyl aminopropyl methacrylamide. In addition monomers like vinyl formamide and vinyl acetamide that can be hydrolyzed to vinyl amine after polymerization may also be used.

Cationic monomers include the quarternized derivatives of the above monomers, as well as diallyl dimethyl ammonium chloride, methacryl amido propyl trimethyl ammonium chloride.

Furthermore, aromatic amine monomers such as vinyl pyridine may also be used. Other amine-containing monomers could also be polymerized into the polymer to provide the amine functionality. These include, but are not limited to sulfobetaines and carboxybetaines.

The functionalized copolymer could contain a mixture of both hydroxyl and amine functional monomers. It was found that copolymers containing lower levels of these functional monomers were more flexible than copolymers containing higher levels of these functional monomers. While not being bound to any particular theory, it is believed this may be related to the lower T_{g} copolymers that are formed. Amide-functional monomers could also be used to form the copolymer if a higher cure temperature is used in forming the finished non-woven.

The mole ratio of acid-functional monomer to hydroxyl-, amide or amine-functional monomer is preferably from 100:1 to 1:1, and more preferably from 5:1 to 1.5:1.

Other ethylenically unsaturated monomers may also be used to form the copolymer binder, at a level of up to 50 mole percent based on the total monomer. These monomers can be used to obtain desirable properties of the copolymer in ways known in the art. For example, hydrophobic monomers can be used to increase the water-resistance of the non-woven. Monomers can also be use to adjust the T_{g} of the copolymer to meet the end-use application requirements. Useful monomers include, but are not limited to, (meth)acrylates, maleates, (meth)acrylamides, vinyl esters, itaconates, styrenics, acrylonitrile, nitrogen functional monomers, vinyl esters, alcohol functional monomers, and unsaturated hydrocarbons. Low levels of up to a few percent of crosslinking monomers may also be used to form the polymer. The extra crosslinking improves the strength of the bonding, yet at higher levels would be detrimental to the flexibility of the resultant material. The crosslinking moieties can be latent crosslinking where the crosslinking reaction takes place not during polymerization but during curing of the binder. Chain-transfer agent may also be used as known in the art in order to regulate chain length and molecular weight. The chain transfer agents may be multifunctional so as to produce star type polymers.

The functionalized copolymer is synthesized by known methods of polymerization, including solution, emulsion, suspension and inverse emulsion polymerization methods. In one preferred embodiment, the polymer is formed by solution polymerization in an aqueous medium. The aqueous medium can be water or a mixed water/water-miscible solvent system, such as a water/alcohol solution. The polymerization can be batch, semi-batch or continuous. The polymers are typically prepared by free radical polymerization, but condensation polymerization can also be used to produce a polymer containing the desired moieties. For example, copolymers of poly(aspartate-co-succinimide) can be prepared by condensation polymerization. This copolymer can be further derivatized by alkanolamines to produce a polymer with carboxylic acid as well as hydroxyl moieties. The monomers can be added to the initial charge, added on a delayed basis, or a combination. The copolymer is generally formed at a solids level in the range of 15 to 60 percent, and preferably from 25 to 50 percent, and will have a pH in the range of from 1-5, and preferably from 2-4. One reason a pH of above 2 is preferred is for the hazard classification it will be afforded. The copolymer may be partially neutralized, commonly with sodium, potassium, or ammonium hydroxides. The choice of base and the partial-salt formed affect the T_{g} of the copolymer. The use of calcium or magnesium base for neutralization produces partial salts having unique solubility characteristics, making them quite useful depending on end-use application.

The copolymer binder can be random, block, star, or other known polymer architecture. Random polymers are preferred due to the economic advantages; however, other architectures could be useful in certain end-uses. Copolymers useful as fiberglass binders will have weight average molecular weights in the range of 1,000 to 300,000, and preferably in the range of 2,000 to 15,000. The molecular weight of the copolymer is preferably in the range of 2,500 to 10,000, and most preferably from 3,000 to 6,000.

The functionalized copolymer binder can form strong bonding without the need for a catalyst or accelerator. One advantage of not using a catalyst in the binder composition is that catalysts tend to produce films that can discolor, or films that release phosphorous-containing vapors. Copolymers of the present invention, used without a catalyst, form a clear film.

An accelerator or catalyst may preferentially be combined with the copolymer binder in order to decrease the time for cure, increase crosslinking density, reduce curing time, and/or decrease water sensitivity of the cured binder. Catalysts useful with the binder are those known in the art including, but not limited to, alkali metal salts of a phosphorous-containing organic acid, such as sodium hypophosphate, sodium phosphite, potassium phosphite, disodium pyrophosphate, tetrasodium pyrophosphate, sodium tripolyphosphate, sodium hexametaphosphate, potassium polyphosphate, potassium tripolyphosphate, sodium trimetaphosphate, sodium tetrametaphosphate, fluouroborates and mixtures thereof. The catalyst could also be a Lewis acid such as magnesium citrate or magnesium chloride, a Lewis base, or a free radical generator such as a peroxide. The catalyst is present in the binder formulation at from 0 to 25 percent by weight, and more preferably from 1 to 10 percent by weight based on the copolymer binder.

Optionally, additional hydroxyl, polyol, or amine components may be admixed with the copolymer binder as crosslinking agents. Since the copolymer contains internal hydroxy or amine groups, the external crosslinkers are not required. Useful hydroxyl compounds include, but are not limited to, trihydric alcohol, beta-hydroxy alkyl amides, polyols, especially those having molecular weights of less than 10,000, ethanol amines such as triethanol amine, hydroxy alkyl urea and oxazolidone. Useful amines include, but are not limited to, triethanol amine and polyamines having two or more amine groups, such as diethylene triamine, tetratethylene pentamine, and polyethylene imine. Preferably, the polyamine contains no hydroxy groups. The polyol or amine, in addition to providing additional cross-linking, also serves to plasticize the polymer film. Other amine crosslinkers include the KYMENE® amide-amine copolymers available from Hercules, and amide-amine copolymers of epichlorohydrin.

The polyamine crosslinkers can be used to crosslink both functionalized and non-functionalized polymer binders, including homopolymer binders such as polymethacrylic acid and polyacrylic acid.

The copolymer binder may optionally be formulated with one or more adjuvants, such as, for example, coupling agents, dyes, pigments, oils, fillers, thermal stabilizers, emulsifiers, curing agents, wetting agents, biocides, plasticizers, anti-foaming agents, waxes, flame-retarding agents, and lubricants. The adjuvants are generally added at levels of less than 20 percent, based on the weight of the copolymer binder.

The copolymer binder composition is useful for bonding fibrous substrates to form a formaldehyde-free non-woven material. The copolymer binder of the invention is especially useful as a binder for heat-resistant non-wovens, such as, for example, aramid fibers, ceramic fibers, metal fibers, polyrayon fibers, polyester fibers, carbon fibers, polyimide fibers, and mineral fibers such as glass fibers. The binder is also useful in other formaldehyde-free applications for binding fibrous substances such as wood, wood chips, wood particles and wood veneers, to form plywood, particleboard, wood laminates, and similar composites.

The copolymer binder composition is generally applied to a fiber glass mat as it is being formed by means of a suitable spray applicator, to aid in distributing the binder evenly throughout the formed fiberglass mat. Typical solids of the aqueous solutions are about 5 to 12 percent. The binder may also be applied by other means known in the art, including, but not limited to, airless spray, air spray, padding, saturating, and roll coating. The residual heat from the fibers causes water to be volatilized from the binder, and the high-solids binder-coated fiberglass mat is allowed to expand vertically due to the resiliency of the glass fibers. The fiberglass mat is then heated to cure the binder. Typically the curing oven operates at a temperature of from 130° C. to 325° C. The fiberglass mat is typically cured from 5 seconds to 15 minutes, and preferably from 30 seconds to 3 minutes. The cure temperature will depend on both the temperature and the level of catalyst used. The fiberglass mat may then be compressed for shipping. An important property of the fiberglass mat is that it will return to its full vertical height once the compression is removed.

Properties of the finished non-woven (fiberglass) include the clear appearance of the film. The clear film may be dyed to provide any desired color. The copolymer binder produces a flexible film that allows the fiberglass insulation to bounce back after unwrapping the roll and using it in walls/ceilings.

Fiberglass, or other non-woven treated with the copolymer binder composition is useful as insulation for heat or sound in the form of rolls or batts; as a reinforcing mat for roofing and flooring products, ceiling tiles, flooring tiles, as a microglass-based substrate for printed circuit boards and battery separators; for filter stock and tape stock and for reinforcements in both non-cementatious and cementatious masonry coatings.

### EXAMPLES

The following examples are presented to further illustrate and explain the present invention and should not be taken as limiting in any regard.

### Example 1

A reactor containing 598.0 grams of water was heated to 94° C. A mixed monomer solution containing 309.0 grams of methacrylic acid and 7.6 grams of hydroxyethyl methacrylate was added to the reactor over a period of 3.5 hours. An initiator solution comprising of 21.2 grams of sodium persulfate in 127.5 grams of deionized water was simultaneously added to the reactor over a period of 3 hours and 50 minutes. The reaction product was held at 94° C. for an additional hour.

### Example 2

A reactor containing 598.0 grams of water was heated to 94° C. A mixed monomer solution containing 275.0 grams of methacrylic acid and 46.2 grams of hydroxyethyl methacrylate was added to the reactor over a period of 3.5 hours. An initiator solution comprising of 21.2 grams of sodium persulfate in 127.5 grams of deionized water was simultaneously added to the reactor over a period of 3 hours and 50 minutes. The reaction product was held at 94° C. for an additional hour.

### Example 3

A reactor containing 598.0 grams of water was heated to 94° C. A mixed monomer solution containing 309.0 grams of methacrylic acid and 7.6 grams of dimethyl aminoethyl methacrylate was added to the reactor over a period of 3.5 hours. An initiator solution comprising of 21.2 grams of sodium persulfate in 127.5 grams of deionized water was simultaneously added to the reactor over a period of 3 hours and 50 minutes. The reaction product was held at 94° C. for an additional hour. The reaction was cooled and then neutralized with ammonia solution to a pH of 7.0.

### Example 4

A reactor containing 158.0 grams of water was heated to 94° C. A monomer solution containing 81.8 grams of methacrylic acid and 20 grams of hydroxyethyl acrylate was added to the reactor over a period of 3.5 hours. An initiator solution comprising of 21.2 grams of sodium persulfate in 127.5 grams of deionized water was simultaneously added to the reactor over a period of 3 hours and 50 minutes. The reaction product was held at 94° C. for an additional hour. The reaction was cooled and then neutralized with 75.2 grams of a 50% NaOH solution.

### Example 5

A reactor containing 184.0 grams of water and 244 grams of isopropanol was heated to 85° C. A monomer solution containing 240 grams of acrylic acid and 60 grams of hydroxypropyl acrylate (12.2 mole %) was added to the reactor over a period of 3.5 hours. An initiator solution comprising of 15 grams of sodium persulfate in 100 grams of deionized water was simultaneously added to the reactor over a period of 4 hours. The reaction product was held at 85° C. for an additional hour. The isopropanol was then distilled using a dean Stark trap. The reaction product was then partially neutralized using 17.6 grams of ammonium hydroxide (28%) solution and 52 grams of deionized water. The polymer solution had 51% solids and a pH of 2.7.

### Example 6

A reactor containing 184.0 grams of water and 244 grams of isopropanol was heated to 85° C. A monomer solution containing 274 grams of acrylic acid and 26 grams of hydroxypropyl acrylate (5 mole %) was added to the reactor over a period of 3.5 hours. An initiator solution comprising of 15 grams of sodium persulfate in 100 grams of deionized water was simultaneously added to the reactor over a period of 4 hours. The reaction product was held at 85° C. for an additional hour. The isopropanol was then distilled using a dean Stark trap. The reaction product was then partially neutralized using 14 grams of ammonium hydroxide (28%) solution and 84 grams of deionized water. The polymer solution had 52% solids and a pH of 2.5.

### Example 7

A reactor containing 184.0 grams of water and 244 grams of isopropanol was heated to 85° C. A monomer solution containing 240 grams of acrylic acid and 53.4 grams of hydroxyethyl acrylate (12.2 mole %) was added to the reactor over a period of 3.5 hours. An initiator solution comprising of 15 grams of sodium persulfate in 100 grams of deionized water was simultaneously added to the reactor over a period of 4 hours. The reaction product was held at 85° C. for an additional hour. The isopropanol was then distilled using a Dean Stark trap. The reaction product was then partially neutralized using 12 grams of ammonium hydroxide (28%) solution and 52 grams of deionized water. The polymer solution had 51% solids and a pH of 2.5.

### Example 8

A reactor containing 184.0 grams of water and 244 grams of isopropanol was heated to 85° C. A monomer solution containing 274 grams of acrylic acid and 23.2 grams of hydroxyethyl acrylate (5 mole %) was added to the reactor over a period of 3.5 hours. An initiator solution comprising of 15 grams of sodium persulfate in 100 grams of deionized water was simultaneously added to the reactor over a period of 4 hours. The reaction product was held at 85° C. for an additional hour. The isopropanol was then distilled using a Dean Stark trap. The reaction product was then diluted with 84 grams of deionized water. The polymer solution had 51% solids.

### Example 9(a)—Comparative

75.2 grams of polyacrylic acid (ALCOSPERSE® 602A from Alco Chemical) and 12.4 grams of triethanol amine (TEA) and 12.4 grams of water was mixed to form a homogenous solution.

### Example 9(b)—Comparative

75.2 grams of polyacrylic acid (ALCOSPERSE® 602A from Alco Chemical) and 12.4 grams of TEA and 5.0 grams of sodium hypophosphite and 7.4 grams of water was mixed to form a homogenous solution.

### Example 10

A reactor containing 300 grams of water was heated to 95° C. A monomer solution containing 200 grams of acrylic acid and 100 grams of hydroxypropyl acrylate was added to the reactor over a period of 2 hours. An initiator solution comprising of 9 grams of sodium persulfate in 60 grams of deionized water was simultaneously added to the reactor over a period of 2 hours and 15 minutes. The reaction product was held at 95° C. for 2 additional hours.

### Example 11

A reactor containing 300 grams of water was heated to 95° C. A monomer solution containing 240 grams of acrylic acid and 60 grams of hydroxypropyl acrylate was added to the reactor over a period of 2 hours. An initiator solution comprising of 9 grams of sodium persulfate in 60 grams of deionized water was simultaneously added to the reactor over a period of 2 hours and 15 minutes. The reaction product was held at 95° C. for 2 additional hours.

### Example 12

The testing protocol was as follows: 20 grams of each of these solutions were poured into poly(methylpentene) (PMP) petri dishes and placed overnight in a forced air oven set at 60° C. They were then cured by being placed for 10 minutes in a forced air oven set at 150° C. After cooling, the resulting films were evaluated in terms of physical appearance, flexibility, and tensile strength.

TABLE 1

| SAMPLE # | | | | |
|---|---|---|---|---|
| (H12-VIII) | COMPOSITION | APPEARANCE | FLEXIBILITY | TENSILE |
| Example 9a | 602A-HS/TEA | “Swiss cheese”, | Low flex, | Breaks readily |
| (Comparative) | | yellow-brown | breaks easily | |
| | | color | | |
| Example 9b | Polyacrylic | “Swiss cheese”, | Slight | Stretches, |
| (comparative) | acid/triethanol | slight yellowing | flexibility, | tensile slightly |
| | amine/sodium | | breaks easily | stronger than |
| | hypophosphite | | | Control |
| Example 10 | PAA/30% HPA | Very clear | Forgiving | Very strong |
| | | colorless film | when bent, | |
| | | | very stiff | |
| Example 11 | PAA/20% HPA | Very clear | Forgiving | Very strong |
| | | colorless film | when bent, | |
| | | | very stiff, does | |
| | | | not shatter | |
| | | | when broken | |

### Example 13

### Example of a Carboxybetaine (Amine-Containing)

A reactor containing 200 grams of water and 244 grams of isopropanol was heated to 85° C. A monomer solution containing 295 grams of acrylic acid and 5 grams of 4-vinylpyridine was added to the reactor over a period of 3.0 hours. An initiator solution comprising of 15 grams of sodium persulfate in 100 grams of deionized water was simultaneously added to the reactor over a period of 3.5 hours. The reaction product was held at 85° C. for an additional hour. The isopropanol was then distilled using a Dean Stark trap. The vinyl pyridine moiety was then functionalized to the carboxy betaine by reaction with sodium chloroacetate at 95 C for 6 hours.

### Example 14

### Example of a Sulfobetaine (Amine-Containing)

A reactor containing 200 grams of water and 244 grams of isopropanol was heated to 85° C. A monomer solution containing 295 grams of acrylic acid and 5 grams of 4-vinylpyridine was added to the reactor over a period of 3.0 hours. An initiator solution comprising of 15 grams of sodium persulfate in 100 grams of deionized water was simultaneously added to the reactor over a period of 3.5 hours. The reaction product was held at 85° C. for an additional hour. The isopropanol was then distilled using a Dean Stark trap. The vinyl pyridine moiety was then functionalized to the sulfobetaine by reaction with sodium chlorohydroxypropane sulfonate at 100° C. for 6 hours.

### Example 15

### Example of a Polymer with a Quaternized Amine Comonomer

A reactor containing 200 grams of water and 244 grams of isopropanol was heated to 85° C. A monomer solution containing 290 grams of acrylic acid and 10 grams of diallyl dimethyl ammonium chloride was added to the reactor over a period of 3.0 hours. An initiator solution comprising of 15 grams of sodium persulfate in 100 grams of deionized water was simultaneously added to the reactor over a period of 3.5 hours. The reaction product was held at 85° C. for an additional hour. The isopropanol was then distilled using a Dean Stark trap.

Although the present invention has been described and illustrated in detail, it is to be understood that the same is by way of illustration and example only, and is not to be taken as a limitation. The spirit and scope of the present invention are to be limited only by the terms of any claims presented hereafter.

1-14. (canceled)

15. A bonded nonwoven mat comprising:
fibrous substances, and
a copolymer binder composition directly deposited onto the fibrous substances, the copolymer binder composition comprising a copolymer having at least one acid functional monomer unit and at least one hydroxyalkyl (meth)acrylate and/or amine functional monomer unit,
wherein the nonwoven mat is formaldehyde free.

16. The nonwoven mat of claim 1 wherein the acid functional monomer unit is present in an amount of from 1 to 99 mole percent of the copolymer; and
the hydroxyalkyl (meth)acrylate and/or amine functional monomer unit is present in an amount of from 1 to 75 mole percent of the copolymer.

17. The nonwoven mat of claim 1 wherein the acid functional monomer is present in an amount of from 50 to 95 mole percent of the copolymer.

18. The nonwoven mat of claim 1 wherein the acid functional monomer is selected from the group consisting of carboxylic acid monomers, phosphonic acid monomers, sulfonic acid monomers or mixtures thereof.

19. The nonwoven mat of claim 4 wherein the carboxylic acid monomers are selected from the group consisting of acrylic acid, methacrylic acid, maleic acid or mixtures thereof.

20. The nonwoven mat of claim 1 wherein the amine functional monomer unit comprises sulfobetaines or carboxybetaines.

21. The nonwoven mat of claim 1 wherein the hydroxyalkyl (meth)acrylate and/or amine functional monomer unit is present in an amount of from 10 to 20 mole percent of the copolymer.

22. The nonwoven mat of claim 1 wherein the acid functional monomer and the hydroxyalkyl (meth)acrylate and/or amine functional monomer unit is present in the copolymer in a mole ratio of from 100:1 to 1:1.

23. The nonwoven mat of claim 1 wherein the copolymer further comprises up to 50 mole percent of non-functional ethylenically unsaturated monomer units.

24. The nonwoven mat of claim 1 wherein the copolymer has a weight average molecular weight of from 1,000 to 300,000.

25. The nonwoven mat of claim 1 wherein the binder composition further comprises from 0 to 25 weight percent of at least one catalyst, based on weight of the copolymer.

26. The nonwoven mat of claim 1 wherein the binder composition further comprises at least a polyamine or amide-amine crosslinking agent.

27. The nonwoven mat of claim 12 wherein the polyamine or amide-amine crosslinking agent contains no hydroxy groups.

28. The nonwoven mat of claim 12 wherein the crosslinking agent is selected from the group consisting of diethylene triamine, tetraethylene pentamine, polyethylene imine, and mixtures thereof.

29. The nonwoven mat of claim 1 wherein the fibrous substances are heat-resistant nonwoven fibers or wood fibers.

30. The nonwoven mat of claim 15 wherein the fibrous substances are heat-resistant nonwoven fibers selected from the group consisting of aramid fibers, ceramic fibers, metal fibers, polyrayon fibers, polyester fibers, carbon fibers, polyimide fibers, mineral fibers and mixtures thereof.
